(19) United States
(12) Patent Application Publication
(10) Pub. No.: US 2026/0088872 A1
(43) Pub. Date: Mar. 26, 2026

(54) CSI REPORTING IN A MULTI-CELL SCHEDULING ENVIRONMENT

(71) Applicant: SHARP KABUSHIKI KAISHA, Sakai City, Osaka (JP)

(72) Inventors: TOMOKI YOSHIMURA, Sakai City, Osaka (JP); ZHANPING YIN, Vancouver, WA (US); KAI YING, Vancouver, WA (US)

(21) Appl. No.: 19/111,917

(22) PCT Filed: Sep. 12, 2023
(86) PCT No.: PCT/JP2023/033184

§ 371 Date: Mar. 14, 2025

Related U.S. Application Data
(60) Provisional application No. 63/407,535, filed on Sep. 16, 2022.

(51) Int. Cl. H04B 7/06; H04L 5/00

(52) U.S. Cl. CPC H04B 7/0626; H04L 5/0044

(57) ABSTRACT

A method for a wireless terminal of a New Radio (NR) system is provided. The method includes receiving, in a physical downlink control channel (PDCCH) associated with a first serving cell of a plurality of serving cells, downlink control information (DCI). The DCI includes configuration information for one or more physical uplink shared channels (PUSCHs), each PUSCH of the one or more PUSCHs being associated with a corresponding one of one or more of the plurality of serving cells. The DCI also includes trigger information to trigger a generation of a channel state information (CSI) report at the wireless terminal. The method further includes generating, in response to receiving the trigger information, the CSI report, selecting the PUSCH associated with one serving cell of the one or more of the plurality of serving cells, and transmitting the CSI report on the PUSCH associated with the one serving cell.

### TECHNICAL FIELD

The present disclosure generally relates to wireless communications and, more specifically, to channel state information (CSI) reporting in a multi-cell scheduling environment of a wireless network (e.g., a fifth generation (5G) (e.g., New Radio (NR)) network).

### BACKGROUND ART

The 3rd Generation Partnership Project (3GPP), in an upcoming Release 18 (Rel-18), may support multi-cell scheduling. In multi-cell scheduling, a single serving cell may transmit a single Downlink Control Information (DCI) format or transmission (e.g., on a Physical Downlink Control Channel (PDCCH) that may include information to schedule multiple Physical Uplink Shared Channels (PUSCHs) for a plurality of serving cells to a wireless terminal (e.g., user equipment, or UE). (See, for example, 3GPP Radio Access Network (RAN) Group Document RP-221435: Revised WID (Work Item Description) on Multi-carrier enhancements.)

As described in greater detail below, within this multi-cell scheduling environment, one potential issue to be addressed is the transmission of a triggered aperiodic Channel State Information (CSI) report from the wireless terminal. More specifically, presuming multiple PUSCHs have been scheduled for a plurality of serving cells, the wireless terminal may select a single one of the PUSCHs on which to transmit the triggered CSI report.

### SUMMARY OF INVENTION

In one example, a wireless terminal for channel status information (CSI) reporting in a multi-cell scheduling environment, the wireless terminal comprising: a transmitter; a receiver; one or more non-transitory computer-readable media storing computer-executable instructions; and at least one processor coupled to the one or more non-transitory computer-readable media and configured to execute the computer-executable instructions to cause the wireless terminal to perform operations comprising: receiving, by the receiver, in a physical downlink control channel (PDCCH) associated with a first serving cell of a plurality of serving cells, downlink control information (DCI) including: configuration information for one or more physical uplink shared channels (PUSCHs), each PUSCH of the one or more PUSCHs being associated with a corresponding one of one or more of the plurality of serving cells, and trigger information to trigger a CSI report at the wireless terminal; generating, in response to receiving the trigger information, the CSI report; selecting the PUSCH associated with one serving cell of the one or more of the plurality of serving cells; and transmitting, by the transmitter, the CSI report on the PUSCH associated with the one serving cell.

### BRIEF DESCRIPTION OF DRAWINGS

Implementations of the present disclosure will now be described, by way of example only, with reference to the attached figures.

FIG. 1 is a communication diagram illustrating a procedure for triggering and transmitting an aperiodic CSI report, according to an example implementation of the present disclosure.

FIG. 2 is a time-frequency diagram illustrating scheduling of PUSCHs for multiple serving cells using a single DCI format transmitted in a PDCCH of a single serving cell, according to an example implementation of the present disclosure.

FIG. 3 is a conceptual block diagram indicating logical components of a wireless terminal, according to an example implementation of the present disclosure.

FIG. 4 is a flowchart illustrating a method for a wireless terminal for transmitting an aperiodic CSI report in a multi-cell environment, according to an example implementation of the present disclosure.

FIG. 5 is a flowchart illustrating a method for selecting a PUSCH associated with one of a plurality of serving cells for transmitting an aperiodic CSI report, according to an example implementation of the present disclosure.

FIG. 6 is a flowchart illustrating another method for selecting a PUSCH associated with one of a plurality of serving cells for transmitting an aperiodic CSI report, according to an example implementation of the present disclosure.

FIG. 7 is a flowchart illustrating yet another method for selecting a PUSCH associated with one of a plurality of serving cells for transmitting an aperiodic CSI report, according to an example implementation of the present disclosure.

FIG. 8 is a flowchart illustrating yet another method for selecting a PUSCH associated with one of a plurality of serving cells for transmitting an aperiodic CSI report, according to an example implementation of the present disclosure.

FIG. 9 is a block diagram illustrating a node for wireless communication, according to an example implementation of the present application.

### DESCRIPTION OF EMBODIMENTS

The 3GPP is a collaboration agreement that aims to define globally applicable technical specifications and technical reports for third and fourth generation wireless communication systems. The 3GPP may also define specifications for next generation mobile networks, systems, and devices.

3GPP Long-Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A), and other standards (e.g., 3GPP Releases 8, 9, 10, 11, 12, 13, 14, 15, and so on) including New Radio (NR), which is also known as 5G. However, the scope of the present disclosure should not be limited in this regard. At least some aspects of the systems and methods disclosed herein may be utilized in other types of wireless communication systems.

A wireless terminal may be an electronic device used to communicate voice and/or data to a base station (BS), which in turn may communicate with a network of devices (e.g., public switched telephone network (PSTN), the Internet, etc.). In describing systems and methods herein, a wireless terminal may alternatively be referred to as a wireless communication device, a mobile station, a UE, a wireless terminal, an access terminal, a subscriber station, a mobile terminal, a remote station, a user terminal, a terminal, a subscriber unit, a mobile device, etc. Examples of wireless terminals may include cellular phones, smart phones, personal digital assistants (PDAs), laptop computers, netbooks, e-readers, wireless modems, etc.

In the 3GPP specifications, a wireless terminal may typically be referred to as a UE. However, as the scope of the present disclosure should not be limited to the 3GPP standards, the terms “UE”, “subscriber station”, and the like may be used interchangeably herein to mean the more general term “wireless terminal.” A UE may also be more generally referred to as a wireless terminal or terminal device.

In the 3GPP specifications, a BS is typically referred to as a NodeB, an evolved NodeB (cNB), a home enhanced or evolved NodeB (HeNB), a Next Generation NodeB (gNB), or some other similar terminology. As the scope of the disclosure should not be limited to 3GPP standards, the terms “base station,” “NodeB,” “eNB,” “HeNB,” and “gNB” may be used interchangeably herein to mean the more general term “base station.” Furthermore, the term “base station” or “BS” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB and/or gNB may also be more generally referred to as a base station device.

It should be noted that, as used herein, a “cell” may be a set of communication channels that is specified by standardization or regulatory bodies to be used for International Mobile Telecommunications-Advanced (IMT-Advanced), and all of IMT-Advanced, or a subset thereof, may be adopted by 3GPP as licensed bands (e.g., frequency bands) to be used for communication between an eNB and a UE. It should also be noted that in the E-UTRA and E-UTRAN overall description, as used herein, a “cell” may be defined as a “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by an eNB and/or gNB to transmit or receive information. “Configured cell(s)” may be serving cell(s). The UE may receive system information and perform the required measurements on all configured cells. “Configured cell(s)” for a radio connection may include a primary cell and/or no, one, or more secondary cell(s).

“Activated cells” are those configured cells on which the UE is transmitting and receiving. That is, activated cells are those cells for which the UE monitors the physical downlink control channel (PDCCH) and, in the case of a downlink transmission, those cells for which the UE decodes a physical downlink shared channel (PDSCH). “Deactivated cells” are those configured cells for which the UE is not monitoring the transmission of PDCCH. It should be noted that a “cell” may be described in terms of differing dimensions. For example, a “cell” may have temporal, spatial (e.g., geographical), and frequency characteristics.

The 5G communication systems, dubbed NR technologies by the 3GPP, envision the use of time/frequency/space resources to allow for services, such as Enhanced Mobile Broadband (eMBB) transmission, Ultra-Reliable Low-Latency Communications (URLLC) transmission, and massive Machine Type Communication (mMTC) transmission. Also, in NR, single-beam and/or multi-beam operations are considered for downlink and/or uplink transmissions.

Various examples of the systems and methods disclosed herein are now described with reference to the figures, where like reference numbers may indicate functionally similar elements. The systems and methods, as generally described and illustrated in the figures herein, could be arranged and designed in a wide variety of different implementations. Therefore, the detailed description of the present disclosure as illustrated in the figures is not intended to limit the scope of the present disclosure but is merely representative of the systems and methods.

According to various implementations of the present disclosure, a mechanism is discussed by which a UE may select one of a plurality of available PUSCHs, each of which is associated with a different serving cell of a plurality of serving cells for transmission of an aperiodic CSI report.

### NR Frame Structure

The 5G NR Frame structure is described in the NR 3GPP standards (e.g., Technical Specification (TS) 38.211). The 5G NR frame structure includes subframes, slots, and symbol configurations. As described above, the 5G NR Supports two frequency ranges: FR1 (which is under 7.125 gigahertz (GHz)) and FR2 (also known as millimeter wave range, which is between 24.25 GHZ and 71.2 GHZ). NR uses flexible subcarrier spacing derived from basic 15 kilohertz (kHz) subcarrier spacing that is also used in LTE. A frame may have a duration of 10 milliseconds (ms) which may consist of 10 subframes each having 1 ms duration, which is similar to LTE networks. Each subframe may have 2″ slots (μ being a member of the set of [0 . . . 4]). Each slot may typically include 14 orthogonal frequency division multiplexing (OFDM) symbols. The radio frames of 10 ms may be transmitted continuously one after the other as per Time Division Duplex (TDD) or Frequency Division Duplex (FDD) topology. A subframe may be of a fixed duration (e.g., 1 ms) whereas a slot's length may vary based on a subcarrier spacing (SCS) and the number of slots per subframe. A slot is 1 ms for 15 kHz, 500 us for 30 kHz, and so on. The subcarrier spacing of 15 kHz may occupy one slot per subframe, whereas the subcarrier spacing of 30 kHz may occupy two slots per subframe, and so on. Each slot may occupy either 14 OFDM symbols or 12 OFDM symbols depending on the normal cyclic prefix (CP) or extended CP, respectively.

In 5G, a resource grid (RG) is the grouping of uplink (UL) or downlink (DL) resources at the physical layer of a given numerology (described below). The time domain is usually expressed as symbols of a slot, and as slots of a subframe, and the frequency domain is typically expressed as the available resource block (RB) (also described below) within the transmission bandwidth.

In 5G, a resource element (RE) is the smallest physical resource in NR that may include one subcarrier during one OFDM symbol. Also, in 5G, one NR Resource Block (RB) may contain 12 sub-carriers in the frequency domain, irrespective of the numerology, and is defined only in the frequency domain (e.g., the bandwidth may not be fixed and may be dependent upon the configured sub-carrier spacing). Additionally, in 5G, Physical Resource Blocks (PRBs) are the RBs that are used for actual/physical transmission/reception.

### NR Numerology

Numerology is a term used in the 3GPP specifications to describe the different subcarrier spacing types, as there are several different types of subcarrier spacing as summarized in the following Table 1 (which is similar to the Table 4.2-1 in TS 38.211) that defines the supported transmission numerologies.

TABLE 1

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

It should be noted that, for the remainder of this disclosure, the terms numerology and subcarrier spacing (SCS) may be used interchangeably. It should also be noted that the term “SCS configuration factor n” may be used to refer to a subcarrier spacing type, where n may belong to the set [0,1,2,3,4], as noted in the table above and is referred to as u.

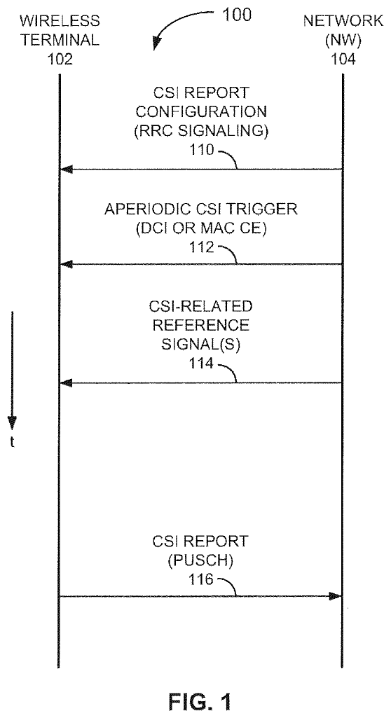

As described in greater detail below, various implementations of the present disclosure include wireless terminal selection of a PUSCH associated with one of a plurality of serving cells on which to transmit an aperiodic CSI report. FIG. 1 is a communication diagram illustrating a procedure 100 for triggering and transmitting an aperiodic CSI report, according to an example implementation of the present disclosure.

In the procedure 100, a network (NW) 104 (e.g., a serving cell of a network using one or more BSs) may transmit a CSI report configuration 110 (e.g., by way of Radio Resource Control (RRC) signaling) to a wireless terminal 102. In some implementations, the CSI report configuration 110 may include information regarding one or more types of CSI-related reference signals (e.g., a CSI Reference Signal CSI-RS, a Synchronization Signal Block (SSB), etc.) to be monitored, one or more sets of resource elements (REs) the CSI-related reference signals may occupy, and so on. Thereafter, the NW 104 may transmit an aperiodic CSI trigger 112 (e.g., by way of DCI, a Media Access Control (MAC) Control Element (CE), etc.) to the wireless terminal 102 to trigger or initiate the monitoring of the CSI-related reference signals by the wireless terminal 102.

In response to receiving the aperiodic CSI trigger 112, the wireless terminal 102 may monitor the CSI-related reference signals 114 (e.g., the CSI-related reference signals indicated in the CSI report configuration 110). During the monitoring, the wireless terminal 102 may take measurements of the CSI-related reference signals 114 and generate various indicator values (e.g., Channel Quality Indicator (CQI), Rank Indicator (RI), etc.) to be provided in an aperiodic CSI report 116 transmitted to the NW 104 (e.g., on a PUSCH). In some embodiments, the wireless terminal 102 may have completed monitoring of the CSI-related reference signals 114 before the aperiodic CSI trigger 112 is received at the wireless terminal 102.

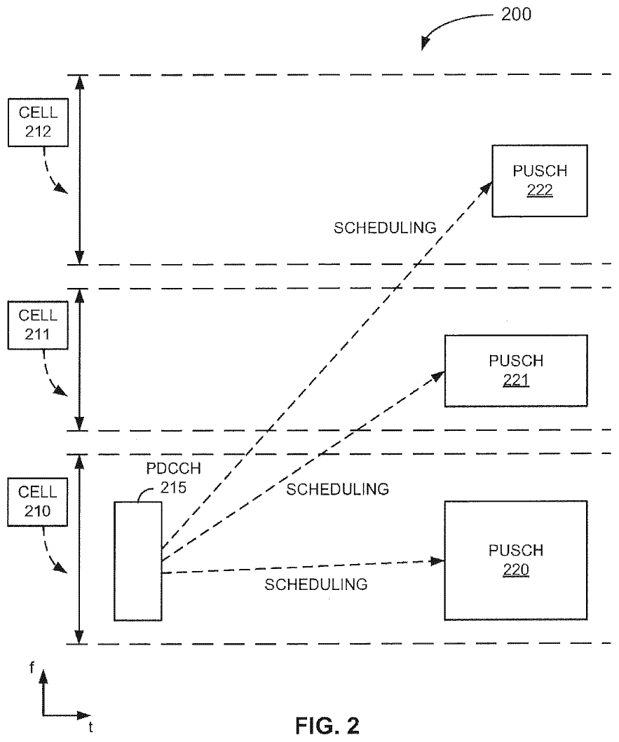

As indicated above, the procedure 100 may be rendered more complex within a multi-cell scenario. FIG. 2 is a time-frequency diagram 200 illustrating scheduling of PUSCHs 220, 221, and 222 for multiple serving cells 210, 211, and 212, respectively, using a single DCI transmission or format transmitted in a PDCCH 215 associated with a single serving cell (e.g., serving cell 210), according to an example implementation of the present disclosure. As used herein, the term “DCI” may refer to Downlink Control Information transmitted by the NW 104 to the wireless terminal 102, and the term “DCI format” may refer to the particular types of DCI and their format or arrangement within a single DCI transmission. Consequently, the terms “DCI”, “DCI format”, and “DCI transmission” may be interchangeably used herein.

As indicated in FIG. 2, vertical dimensions correspond to a frequency domain (f), while horizontal dimensions are related to a time domain (t). In the illustrated example, each serving cell 210, 211, and 212 corresponds to a particular contiguous bandwidth (e.g., set of carrier frequencies) employable in the communication system for transmission and reception of signals with wireless terminals (e.g., wireless terminal 102). However, other examples are not limited in such a manner, as one or more serving cells 210, 211, and 212 may employ carrier frequencies that are not grouped as a continuous set and may be interspersed among carrier frequencies of other serving cells.

In some implementations, the serving cells 210, 211, and 212 may all belong to the same cell group or the same set of cell groups (e.g., a Master Cell Group (MCG), a Secondary Cell Group (SCG), an MCG and associated SCG, etc.). However, other implementations of the present disclosure are not limited in such a manner, as the serving cells 210, 211, and 212 may be associated in other ways (e.g., as being associated with the same PUCCH cell group).

As shown in FIG. 2, a first serving cell (e.g., serving cell 210) may transmit, in a PDCCH 215, configuration information (e.g., scheduling information in a DCI format) for a separate PUSCH associated with each of the serving cells 210, 211, and 212. In some implementations, the configuration information may identify particular resource blocks (RBs), resource elements (REs), and/or time-frequency resources that the PUSCH associated with each serving cell 210, 211, and 212 may occupy. As indicated in FIG. 2, each PUSCH 220, 221, and 222 may be different in terms of the number of time-frequency resources used, the carrier frequencies involved, the starting time and/or duration of each PUSCH, and so on. In other implementations, two or more of the PUSCHs 220, 221, and 222 may share one or more of the aforementioned qualities.

While FIG. 2 indicates that the first serving cell 210 provides configuration information for each PUSCH associated with each of the serving cells 210, 211, and 212, the configuration information may not provide scheduling information for a PUSCH associated with every serving cell with which the first serving cell 210 is associated, in some implementations. In other words, the single DCI transmission or format in PDCCH 215 may carry PUSCH scheduling information for only a subset of the plurality of serving cells 210, 211, and 212. Further, in some implementations, the first serving cell 210 may not currently provide information for a PUSCH for its own serving cell (e.g., PUSCH 220 in FIG. 2).

In some implementations, the configuration information may be included in a DCI format. Further, the DCI format, in addition to the configuration or scheduling information described above, may include an aperiodic CSI trigger indication (e.g., aperiodic CSI trigger 112 of FIG. 1) that is to be received by the wireless terminal 102. In response to receiving such a trigger, the wireless terminal 102 may monitor CSI-related reference signals (e.g., CSI-related reference signals of FIG. 1) to generate a CSI report to be transmitted back to the NW 104 (e.g., aperiodic CSI report 116 of FIG. 1) in a PUSCH.

In the scenario of FIG. 2, given that a plurality of PUSCHs 220, 221, and 222 are available among the plurality of serving cells 210, 211, and 212, an operation that the wireless terminal 102 may perform before transmitting the CSI report may include selecting one of the PUSCHs 220, 221, and 222 for transmission of the aperiodic CSI report 116. In at least some environments, the transmission of the CSI report over multiple PUSCHs may be problematic. For example, a PUSCH carrying an aperiodic CSI report may also play an important role for other purposes, such as Uplink Channel Information (UCI) multiplexing, which may typically require that only one PUSCH be used for transmitting such information. Therefore, in some cases, the number of PUSCHs carrying an aperiodic CSI report may need to be limited to a maximum threshold (e.g., one PUSCH).

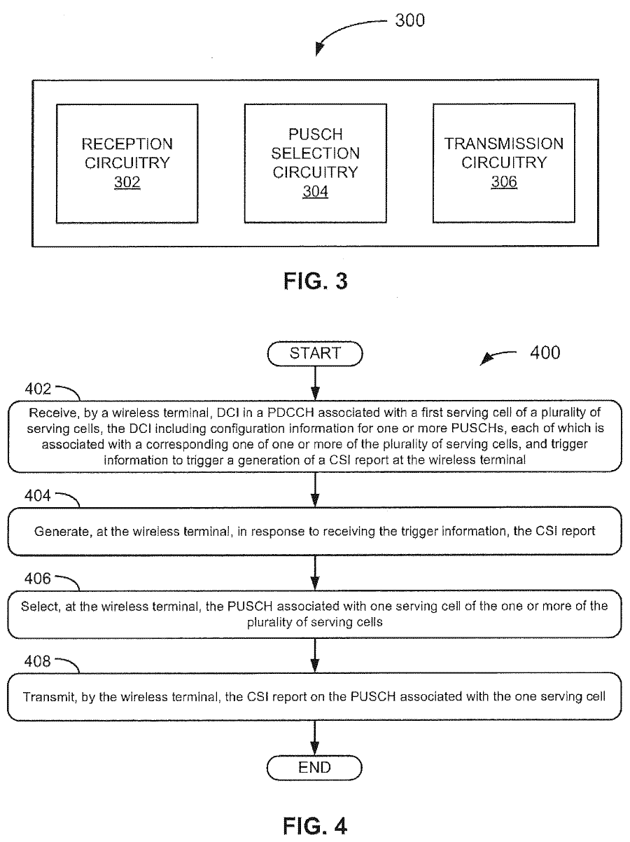

FIG. 3 is a conceptual block diagram indicating logical components of a wireless terminal 300, according to an example implementation of the present disclosure. As shown in FIG. 3, the wireless terminal 300 may include reception circuitry 302, PUSCH selection circuitry 304, and transmission circuitry 306. Other components and features may be included in the wireless terminal 300 but are not shown or discussed herein for the sake of brevity and to focus on and simplify the following discussion. Each of reception circuitry 302, PUSCH selection circuitry 304, and transmission circuitry 306 may include electronic hardware (e.g., analog and/or digital circuitry), with or without software or firmware that may include one or more memories storing computer-executable instructions that, when executed by one or more processors (e.g., microprocessors, microcontrollers, digital signal processors (DSPs), application-specific integrated circuits (ASICs), and the like), causes the wireless terminal to perform operations described hereinafter. For example, the operation(s) that may be performed by each of the components 302, 304, and 306 are described below with reference to the following figures, such as FIGS. 4-8.

FIG. 4 is a flowchart illustrating a method 400 performed by a wireless terminal (e.g., wireless terminal 300) for transmitting an aperiodic CSI report in a multi-cell environment, according to an example implementation of the present disclosure. While the following method 400 and others outlined herein are described in conjunction with wireless terminal 300, other wireless terminals not specifically described herein may also perform such methods in other implementations. Additionally, while a particular order of execution is discussed for each method presented herein, other orders of execution, including the addition or removal of one or more operations, are also possible.

In the method 400, at operation 402, wireless terminal 300 may receive, by the reception circuitry 302 (e.g., as shown in FIG. 3), DCI in a PDCCH associated with a first serving cell of a plurality of serving cells. In some implementations, the DCI may include configuration information for one or more PUSCHs, each of which is associated with a corresponding serving cell of one or more of the plurality of serving cells, as well as trigger information to trigger the generation of a CSI report at the wireless terminal 300.

In some implementations, the configuration information, as described below, may allow the wireless terminal 300 to determine or derive information necessary to perform the operations described herein. In some examples, the configuration information may explicitly state or indicate the information needed by the wireless terminal 300, or may provide such information indirectly (e.g., by allowing the wireless terminal 300 to use that information to calculate or derive the necessary information).

In some implementations, the configuration information may include first information indicating a subset (e.g., one or more, including possibly all) of the plurality of serving cells having a PUSCH that is configured or scheduled. Using FIG. 2 as an example, serving cells 210, 211, and 212 may be a subset of a greater number of serving cells, where each serving cell of the subset includes a PUSCH scheduled by the configuration of the DCI. In other examples, serving cells 210, 211, and 212 may represent both the total number of serving cells and the subset of serving cells having a scheduled PUSCH. In other examples, of all serving cells for the wireless terminal 300, the subset of serving cells may be as few as two serving cells and as many as all of the serving cells.

In some implementations, the configuration information may include second information providing a configuration for each PUSCH associated with the subset of the plurality of serving cells. The second information may include, but is not necessarily limited to, time-frequency resources, Demodulation Reference Signal (DMRS) ports, New Data Indicators (NDI), Redundancy Versions (RV), Hybrid Automatic Repeat Request (HARQ) process numbers, etc., associated with the PUSCHs.

In some implementations, the configuration information may include third information indicating that a CSI report is being triggered (e.g., an aperiodic CSI report) in the wireless terminal 300.

In some implementations, the configuration information may include fourth information indicating a PUSCH associated with one of the subset of serving cells in which an aperiodic CSI report triggered in the wireless terminal 300 is to be transmitted (e.g., multiplexed).

At operation 404 of the method 400, the wireless terminal 300 may generate, in response to receiving the trigger indicator(s) (e.g., the third information of the configuration information), the aperiodic CSI report. In some implementations, the wireless terminal 300 may generate the aperiodic CSI report based on measurements of one or more CSI-related reference signals received by the reception circuitry 302 (e.g., as determined by way of a CSI report configuration received at the wireless terminal 300 (e.g., via RRC signaling, as depicted in FIG. 1)).

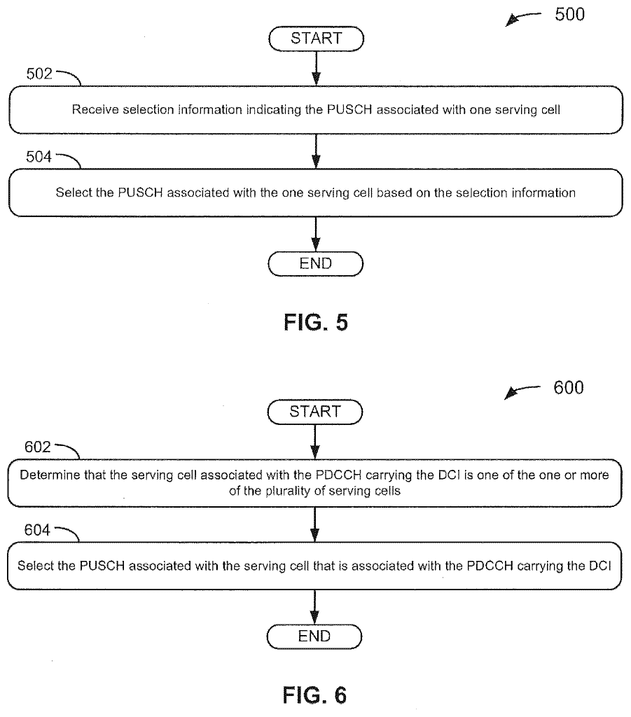

At operation 406, the wireless terminal 300 may select, by way of the PUSCH selection circuitry 304, the PUSCH associated with one serving cell of the subset of serving cells. As described more fully below in conjunction with FIGS. 5-7, the selection of the PUSCH may be based on the configuration information received in the DCI and/or based on other information received by, or stored in, the wireless terminal 300.

At operation 408, the wireless terminal 300, by way of the transmission circuitry 306, may transmit the generated aperiodic CSI report on the selected PUSCH.

FIG. 5 is a flowchart illustrating a method 500 for selecting the PUSCH associated with one of one or more of a plurality of serving cells (e.g., one of a subset of the plurality of serving cells, as mentioned above) for transmitting an aperiodic CSI report, according to an example implementation of the present disclosure. In some implementations, the method 500 serves as an example of the selection operation 406 of method 400 of FIG. 4.

In the method 500, at operation 502, the wireless terminal 300, by the reception circuitry 302, may receive selection information indicating a PUSCH associated with one serving cell on which the aperiodic CSI report is to be transmitted. In some examples, the selection information may be included or indicated in the configuration information in the DCI format (e.g., the fourth information of the configuration information in the DCI format). In other examples, the selection information may be included or indicated in RRC signaling (e.g., received from the NW 104 of FIG. 1). In yet other examples, the selection information may be received or stored in the wireless terminal 300 via other means.

At operation 504, the wireless terminal 300, by the PUSCH selection circuitry 304, may select the PUSCH associated with the one serving cell as the PUSCH on which the aperiodic CSI report is to be transmitted. Consequently, in the method 500, the wireless terminal 300 receives an explicit indication of the specific PUSCH to be selected or receives information from which the specific PUSCH is to be determined.

FIG. 6 is a flowchart illustrating another method for selecting a PUSCH associated with one of a plurality of serving cells for transmitting an aperiodic CSI report, according to an example implementation of the present disclosure. In some implementations, the method 600 serves as an example of the selection operation 406 of method 400 of FIG. 4.

In the method 600, at operation 602, the wireless terminal 300, by the PUSCH selection circuitry 304, may determine that the serving cell associated with the PDCCH carrying the DCI (e.g., the first serving cell 210 carrying the PDCCH 215, as shown in FIG. 2) is one of the one or more of the plurality of serving cells (e.g., one of the subset of the plurality of serving cells having a scheduled PUSCH). At operation 604, the wireless terminal 300, by the PUSCH selection circuitry 304, may select the PUSCH associated with the serving cell that is associated with the PDCCH carrying the DCI (e.g., PUSCH 220, as shown in FIG. 2). In other words, if the serving cell associated with the PDCCH carrying the DCI is also associated with one of the PUSCHs configured by the configuration information of the DCI, the wireless terminal 300 may select the PUSCH associated with that serving cell for transmitting the aperiodic CSI report.

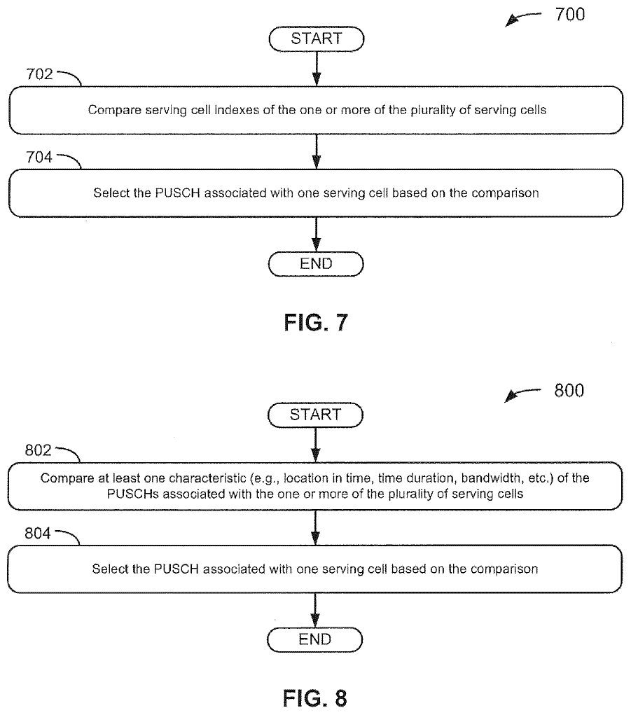

FIG. 7 is a flowchart illustrating yet another method 700 for selecting a PUSCH associated with one of a plurality of serving cells for transmitting an aperiodic CSI report, according to an example implementation of the present disclosure. In some implementations, the method 700 serves as an example of the selection operation 406 of method 400 of FIG. 4.

In the method 700, at operation 702, the wireless terminal 300, by the PUSCH selection circuitry 304, may compare serving cell indexes of the one or more of the plurality of serving cells (e.g., the subset of the plurality of serving cells). At operation 704, the wireless transmitter, by the PUSCH selection circuitry 304, may select the PUSCH associated with one serving cell of the one or more of the plurality of serving cells based on the comparison. As indicated above, the one or more of the plurality of serving cells may be a group of serving cells for which a single DCI transmission schedules a PUSCH in each of the serving cells of the group.

For example, the PUSCH selection circuitry 304 may be configured to select a PUSCH associated with the serving cell with the lowest serving cell index among the one or more of the plurality of serving cells. In another example, the PUSCH selection circuitry 304 may be configured to select a PUSCH associated with the serving cell with the highest serving cell index among the one or more of the plurality of serving cells.

FIG. 8 is a flowchart illustrating yet another method 800 for selecting a PUSCH associated with one of a plurality of serving cells for transmitting an aperiodic CSI report, according to an example implementation of the present disclosure. In some implementations, the method 800 serves as an example of the selection operation 406 of method 400 of FIG. 4.

In the method 800, at operation 802, the wireless terminal 300, by the PUSCH selection circuitry 304, may compare at least one characteristic or aspect (e.g., location in time, time duration, bandwidth, etc.) of the PUSCHs associated with the one or more of the plurality of serving cells (e.g., the subset of the plurality of serving cells). At operation 804, the wireless terminal 300, by the PUSCH selection circuitry 304, may select the PUSCH associated with one serving cell of the one or more of the plurality of serving cells based on the comparison.

In some implementations, one or more time domain aspects or characteristics of the time-frequency resources of each of the PUSCHs associated with the one or more of the plurality of serving cells may be compared to determine which PUSCH to select.

In some implementations, the PUSCH selection circuitry 304 may be configured to select a PUSCH based on the starting slot of each PUSCH among the one or more of the plurality of serving cells. For example, the PUSCH selection circuitry 304 may be configured to select the PUSCH starting at the earliest timing among the PUSCHs associated with the one or more of the plurality of serving cells. In another example, the PUSCH selection circuitry 304 may be configured to select the PUSCH starting at the carliest slot among the PUSCHs associated with the one or more of the plurality of serving cells. In another example, the PUSCH selection circuitry 304 may be configured to select the PUSCH starting at the earliest OFDM symbol among the PUSCHs associated with the one or more of the plurality of serving cells.

In some implementations, the PUSCH selection circuitry 304 may be configured to select a PUSCH based on the length (e.g., the duration in the time domain) of each PUSCH among the one or more of the plurality of serving cells. For example, the PUSCH selection circuitry 304 may be configured to select the PUSCH with the longest length in time among the PUSCHs associated with the one or more of the plurality of serving cells. In another example, the PUSCH selection circuitry 304 may be configured to select the PUSCH with the highest number of OFDM symbols among the PUSCHs associated with the one or more of the plurality of serving cells. In another example, the PUSCH selection circuitry 304 may be configured to select the PUSCH with the highest number of OFDM symbols per slot among the PUSCHs associated with the one or more of the plurality of serving cells.

In some implementations, the PUSCH selection circuitry 304 may be configured to select a PUSCH based on a frequency bandwidth of each PUSCH among the one or more of the plurality of serving cells. For example, the PUSCH selection circuitry 304 may be configured to select the PUSCH with the largest frequency bandwidth among the PUSCHs associated with the one or more of the plurality of serving cells. In another example, the PUSCH selection circuitry 304 may be configured to select the PUSCH with the smallest frequency bandwidth among the PUSCHs associated with the one or more of the plurality of serving cells.

In some implementations, the PUSCH selection circuitry 304 may be configured to select a PUSCH based on a number of resource blocks (RBs) of each PUSCH among the one or more of the plurality of serving cells. For example, the PUSCH selection circuitry 304 may be configured to select the PUSCH with the largest number of RBs among the PUSCHs associated with the one or more of the plurality of serving cells. In another example, the PUSCH selection circuitry 304 may be configured to select the PUSCH with the smallest number of RBs among the PUSCHs associated with the one or more of the plurality of serving cells.

In some implementations, the PUSCH selection circuitry 304 may be configured to select a PUSCH based on a number of resource elements (REs) of each PUSCH among the one or more of the plurality of serving cells. For example, the PUSCH selection circuitry 304 may be configured to select the PUSCH with the largest number of REs among the PUSCHs associated with the one or more of the plurality of serving cells. In another example, the PUSCH selection circuitry 304 may be configured to select the PUSCH with the smallest number of REs among the PUSCHs associated with the one or more of the plurality of serving cells.

In some implementations, the PUSCH selection circuitry 304 may be configured to select a PUSCH based on a combination of two or more of the various factors discussed above in conjunction with FIGS. 5-7 (e.g., evaluated in an order of priority).

For example, in some implementations, the PUSCH selection circuitry 304 may be configured to determine whether the one or more of the plurality of serving cells (e.g., the subset of the plurality of serving cells) includes the serving cell with the PDCCH carrying the DCI (e.g., the first serving cell 210 of FIG. 2). If the one or more of the plurality of serving cells includes the serving cell with the PDCCH carrying the DCI, the PUSCH selection circuitry 304 may select the PUSCH associated with that serving cell to transmit the aperiodic CSI report. Otherwise, the PUSCH selection circuitry 304 may compare at least one of the aspects described above (e.g., serving cell indexes, time-related aspects, frequency-related aspects, etc.) associated with the PUSCHs associated with the one or more of the plurality of serving cells to select one of the PUSCHs to transmit the aperiodic CSI report. For example, if the one or more of the plurality of serving cells does not include the serving cell with the PDCCH carrying the DCI, the PUSCH selection circuitry 304 may select the PUSCH associated with the serving cell having the lowest (or highest) serving cell index of the one or more of the plurality of serving cells.

In some implementations, the PUSCH selection circuitry 304 may be configured to determine one or more PUSCHs based on the earliest slot among the PUSCHs associated with the one or more of the plurality of serving cells (e.g., the subset of the plurality of serving cells). If a number of the one or more PUSCHS is one (e.g., if only one of the PUSCHs associated with the one or more of the plurality of serving cells occupies the earliest slot), the PUSCH selection circuitry 304 may select that PUSCH to transmit the aperiodic CSI report. If, instead, the number of the one or more PUSCHS is greater than one (e.g., if more than one of the PUSCHs associated with the one or more of the plurality of serving cells occupies the earliest slot), the PUSCH selection circuitry 304 may instead select the PUSCH associated with the one serving cell having the lowest (or highest) serving cell index among the one or more of the plurality of serving cells.

While certain specific combinations of the various factors discussed above are described in detail, others not specifically discussed herein may also be evaluated by the PUSCH selection circuitry 304 to select a PUSCH from the PUSCHs associated with the one or more of the plurality of serving cells having a scheduled PUSCH.

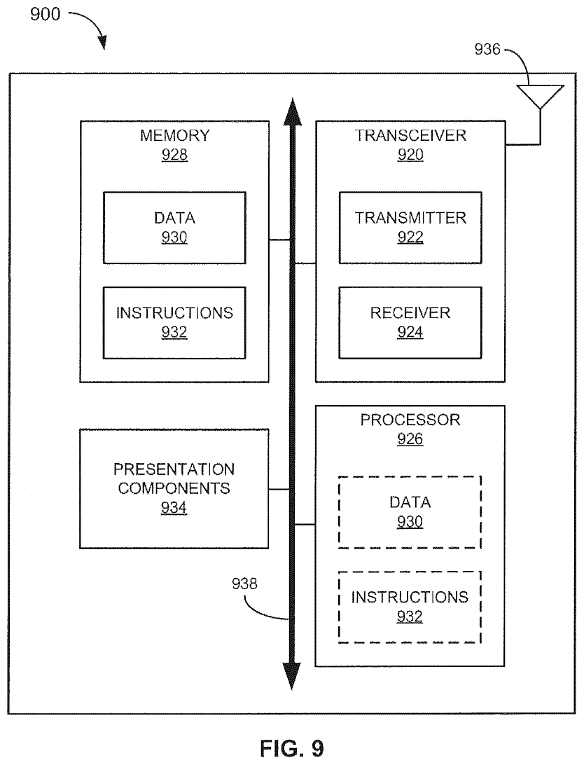

FIG. 9 illustrates a block diagram of a node for wireless communication, according to one example implementation of the present application. As shown in FIG. 9, node 900 may include a transceiver 920, processor 926, memory 928, one or more presentation components 934, and at least one antenna 936. Node 900 may also include a Radio Frequency (RF) spectrum band module, a base station communications module, a network communications module, and a system communications management module, input/output (I/O) ports, I/O components, and power supply (not explicitly shown in FIG. 9). Each of these components may be in communication with each other, directly or indirectly, over one or more buses 938.

Transceiver 920 having a transmitter 922 and a receiver 924 may be configured to transmit and/or receive time and/or frequency resource partitioning information. In some implementations, transceiver 920 may be configured to transmit in different types of subframes and slots including, but not limited to, usable, non-usable, and flexibly usable subframes and slot formats. Transceiver 920 may be configured to receive data and control signaling.

Node 900 may include a variety of computer-readable media. Computer-readable media can be any available media that can be accessed by node 900 and include both volatile and non-volatile media, removable and non-removable media. By way of example, and not limitation, computer-readable media may include computer storage media and communication media. Computer storage media include both volatile and non-volatile, removable and non-removable, media implemented in any method or technology for storage of information, such as computer-readable instructions, data structures, program modules, or other data.

Computer storage media include RAM, ROM, EEPROM, flash memory or other memory technology, CD-ROM, digital versatile disks (DVD), or other optical disk storage, magnetic cassettes, magnetic tape, magnetic disk storage, or other magnetic storage devices. Computer storage media do not exclusively include a propagated data signal. Communication media typically embody computer-readable instructions, data structures, program modules, or other data in a modulated data signal, such as a carrier wave, or other transport mechanism and includes any information delivery media. The term “modulated data signal” means a signal that has one or more of its characteristics set or changed in such a manner as to encode information in the signal. By way of example, and not limitation, communication media include wired media, such as a wired network or direct-wired connection, and wireless media, such as acoustic, RF, infrared, and other wireless media. Combinations of any of the above should also be included within the scope of computer-readable media.

Memory 928 may include computer-storage media in the form of volatile and/or non-volatile memory. Memory 928 may be removable, non-removable, or a combination thereof. Exemplary memory includes solid-state memory, hard drives, optical disc drives, etc. As illustrated in FIG. 9, memory 928 may store computer-readable, computer-executable instructions 932 (e.g., software codes) that are configured to, when executed, cause processor 926 to perform various functions described herein, for example, with reference to FIGS. 1 through 8. Alternatively, instructions 932 may not be directly executable by processor 926 but be configured to cause node 900 (e.g., when compiled and executed) to perform various functions described herein.

Processor 926 may include an intelligent hardware device, for example, one or more central processing units (CPUs), microcontrollers, ASICs, etc. Processor 926 may include memory. Processor 926 may process data 930 and instructions 932 received from memory 928, and information through transceiver 920, the baseband communications module, and/or the network communications module. Processor 926 may also process information to be sent to transceiver 920 for transmission through antenna 936, to the network communications module for transmission to a core network.

One or more presentation components 934 present data indications to a person or other device. For example, one or more presentation components 934 include a display device, speaker, printing component, vibrating component, etc.

In some embodiments, the wireless terminal 300 of FIG. 3 may correspond to the node 900 of FIG. 9. More specifically, in some embodiments, the transmitter 922 of the node 900 may serve as the transmission circuitry 306 of the wireless terminal 300, the receiver 924 of the node 900 may serve as the reception circuitry 302 of the wireless terminal 300, and the processor 926, memory 928, and associated data 930 and instructions 932 may operate as the PUSCH selection circuitry 304 of the wireless terminal 300.

From the above description, various techniques can be used for implementing the concepts described in the present application without departing from the scope of those concepts. Moreover, while the concepts have been described with specific reference to certain implementations, a person of ordinary skill in the art may recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

In one example, a wireless terminal for channel status information (CSI) reporting in a multi-cell scheduling environment of a New Radio (NR) system, the wireless terminal comprising: a transmitter; a receiver; one or more non-transitory computer-readable media storing computer-executable instructions; and at least one processor coupled to the one or more non-transitory computer-readable media and configured to execute the computer-executable instructions to cause the wireless terminal to perform operations comprising: receiving, by the receiver, in a physical downlink control channel (PDCCH) associated with a first serving cell of a plurality of serving cells, downlink control information (DCI) including: configuration information for one or more physical uplink shared channels (PUSCHs), each PUSCH of the one or more PUSCHs being associated with a corresponding one of one or more of the plurality of serving cells, and trigger information to trigger a generation of a CSI report at the wireless terminal; generating, in response to receiving the trigger information, the CSI report; selecting the PUSCH associated with one serving cell of the one or more of the plurality of serving cells; and transmitting, by the transmitter, the CSI report on the PUSCH associated with the one serving cell.

In one example, the wireless terminal, wherein: the DCI further includes selection information that indicates the PUSCH associated with the one serving cell; and selecting the PUSCH associated with the one serving cell is based on the selection information.

In one example, the wireless terminal, the operations further comprising: receiving, by the receiver, a radio resource control (RRC) message including selection information that indicates the PUSCH associated with the one serving cell, wherein selecting the PUSCH associated with the one serving cell is based on the selection information.

In one example, the wireless terminal, wherein: selecting the PUSCH associated with the one serving cell is based on comparing serving cell indexes of the one or more of the plurality of serving cells.

In one example, the wireless terminal, wherein: selecting the PUSCH associated with the one serving cell is based on comparing positions in a time domain of the PUSCHs associated with the one or more of the plurality of serving cells.

In one example, the wireless terminal, wherein: selecting the PUSCH associated with the one serving cell is based on comparing durations in a time domain of the PUSCHs associated with the one or more of the plurality of serving cells.

In one example, the wireless terminal, wherein: selecting the PUSCH associated with the one serving cell is based on comparing numbers of symbols associated with the PUSCHs associated with the one or more of the plurality of serving cells.

In one example, the wireless terminal, wherein: selecting the PUSCH associated with the one serving cell is based on comparing bandwidths of the PUSCHs associated with the one or more of the plurality of serving cells.

In one example, the wireless terminal, wherein: selecting the PUSCH associated with the one serving cell is based on comparing numbers of resource blocks of the PUSCHs associated with the one or more of the plurality of serving cells.

In one example, the wireless terminal, wherein: selecting the PUSCH associated with the one serving cell is based comparing numbers of resource elements of the PUSCHs associated with the one or more of the plurality of serving cells.

In one example, the wireless terminal, wherein: selecting the PUSCH associated with the one serving cell comprises selecting the PUSCH associated with the first serving cell.

In one example, the wireless terminal, wherein: selecting the PUSCH associated with the one serving cell comprises: if the one or more of the plurality of serving cells includes the first serving cell, selecting the PUSCH associated with the first serving cell; and if the one or more of the plurality of serving cells does not include the first serving cell, selecting the PUSCH associated with a serving cell having a lowest serving cell index of the one or more of the plurality of serving cells.

In one example, the wireless terminal, wherein: selecting the PUSCH associated with the one serving cell comprises: if the one or more of the plurality of serving cells includes the first serving cell, selecting the PUSCH associated with the first serving cell; and if the one or more of the plurality of serving cells does not include the first serving cell, selecting the PUSCH associated with the one serving cell based on at least one of: comparing serving cell indexes of the one or more of the plurality of serving cells, comparing positions in a time domain of the PUSCHs associated with the one or more of the plurality of serving cells, comparing durations in the time domain of the PUSCHs associated with the one or more of the plurality of serving cells, comparing numbers of symbols associated with the PUSCHs associated with the one or more of the plurality of serving cells, comparing bandwidths of the PUSCHs associated with the one or more of the plurality of serving cells, comparing numbers of resource blocks of the PUSCHs associated with the one or more of the plurality of serving cells, or comparing numbers of resource elements of the PUSCHs associated with the one or more of the plurality of serving cells.

In one example, the wireless terminal, wherein: selecting the PUSCH associated with the one serving cell comprises: comparing positions in a time domain of the PUSCHs associated with the one or more of the plurality of serving cells to determine a number of the PUSCHs having an earliest position in the time domain; selecting, based on the number of the PUSCHs having the earliest position in the time domain being equal to one, the PUSCH having the earliest position in the time domain; and selecting, based on the number of the PUSCHs having the earliest position in the time domain being greater than one, the PUSCH associated with a serving cell having a lowest serving cell index of the one or more of the plurality of serving cells.

In one example, the wireless terminal, wherein: selecting the PUSCH associated with the one serving cell comprises: comparing positions in a time domain of the PUSCHs associated with the one or more of the plurality of serving cells to determine a number of the PUSCHs having an earliest position in the time domain; selecting, based on the number of the PUSCHs having the earliest position in the time domain being equal to one, the PUSCH having the earliest position in the time domain; and selecting, based on the number of the PUSCHs having the earliest position in the time domain being greater than one, the PUSCH associated with the one serving cell based on at least one of: comparing serving cell indexes of the one or more of the plurality of serving cells, comparing durations in the time domain of the PUSCHs associated with the one or more of the plurality of serving cells, comparing numbers of symbols associated with the PUSCHs associated with the one or more of the plurality of serving cells, comparing bandwidths of the PUSCHs associated with the one or more of the plurality of serving cells, comparing numbers of resource blocks of the PUSCHs associated with the one or more of the plurality of serving cells, or comparing numbers of resource elements of the PUSCHs associated with the one or more of the plurality of serving cells.

In one example, a method for a wireless terminal for channel status information (CSI) reporting in a multi-cell scheduling environment of a New Radio (NR) system, the method comprising: receiving, in a physical downlink control channel (PDCCH) associated with a first serving cell of a plurality of serving cells, downlink control information (DCI) including: configuration information for one or more physical uplink shared channels (PUSCH), each PUSCH of the one or more PUSCHs being associated with a corresponding one of one or more of the plurality of serving cells, and trigger information to trigger a generation of a CSI report at the wireless terminal; generating, in response to receiving the trigger information, the CSI report; selecting the PUSCH associated with one serving cell of the one or more of the plurality of serving cells; and transmitting the CSI report on the PUSCH associated with the one serving cell.

In one example, the method, wherein: the DCI further includes selection information that indicates the PUSCH associated with the one serving cell; and selecting the PUSCH associated with the one serving cell is based on the selection information.

In one example, the method, further comprising: receiving a radio resource control (RRC) message including selection information that indicates the PUSCH associated with the one serving cell, wherein selecting the PUSCH associated with the one serving cell is based on the selection information.

In one example, the method, wherein: selecting the PUSCH associated with the one serving cell is based on comparing serving cell indexes of the one or more of the plurality of serving cells.

In one example, the method, wherein: selecting the PUSCH associated with the one serving cell is based on comparing positions in a time domain of the PUSCHs associated with the one or more of the plurality of serving cells.

In one example, the method, wherein: selecting the PUSCH associated with the one serving cell is based on comparing durations in a time domain of the PUSCHs associated with the one or more of the plurality of serving cells.

In one example, the method, wherein: selecting the PUSCH associated with the one serving cell is based on comparing numbers of symbols associated with the PUSCHs associated with the one or more of the plurality of serving cells.

In one example, the method, wherein: selecting the PUSCH associated with the one serving cell is based on comparing bandwidths of the PUSCHs associated with the one or more of the plurality of serving cells.

In one example, the method, wherein: selecting the PUSCH associated with the one serving cell is based on comparing numbers of resource blocks of the PUSCHs associated with the one or more of the plurality of serving cells.

In one example, the method, wherein: selecting the PUSCH associated with the one serving cell is based comparing numbers of resource elements of the PUSCHs associated with the one or more of the plurality of serving cells.

In one example, the method, wherein: selecting the PUSCH associated with the one serving cell comprises selecting the PUSCH associated with the first serving cell.

In one example, the method, wherein: selecting the PUSCH associated with the one serving cell comprises: if the one or more of the plurality of serving cells includes the first serving cell, selecting the PUSCH associated with the first serving cell; and if the one or more of the plurality of serving cells does not include the first serving cell, selecting the PUSCH associated with a serving cell having a lowest serving cell index of the one or more of the plurality of serving cells.

In one example, the method, wherein: selecting the PUSCH associated with the one serving cell comprises: if the one or more of the plurality of serving cells includes the first serving cell, selecting the PUSCH associated with the first serving cell; and if the one or more of the plurality of serving cells does not include the first serving cell, selecting the PUSCH associated with the one serving cell based on at least one of: comparing serving cell indexes of the one or more of the plurality of serving cells, comparing positions in a time domain of the PUSCHs associated with the one or more of the plurality of serving cells, comparing durations in the time domain of the PUSCHs associated with the one or more of the plurality of serving cells, comparing numbers of symbols associated with the PUSCHs associated with the one or more of the plurality of serving cells, comparing bandwidths of the PUSCHs associated with the one or more of the plurality of serving cells, comparing numbers of resource blocks of the PUSCHs associated with the one or more of the plurality of serving cells, or comparing numbers of resource elements of the PUSCHs associated with the one or more of the plurality of serving cells.

In one example, the method, wherein: selecting the PUSCH associated with the one serving cell comprises: comparing positions in a time domain of the PUSCHs associated with the one or more of the plurality of serving cells to determine a number of the PUSCHs having an earliest position in the time domain; selecting, based on the number of the PUSCHs having the earliest position in the time domain being equal to one, the PUSCH having the earliest position in the time domain; and selecting, based on the number of the PUSCHs having the earliest position in the time domain being greater than one, the PUSCH associated with the one serving cell based on comparing serving cell indexes of the one or more of the plurality of serving cells.

In one example, the method, wherein: selecting the PUSCH associated with the one serving cell comprises: comparing positions in a time domain of the PUSCHs associated with the one or more of the plurality of serving cells to determine a number of the PUSCHs having an earliest position in the time domain; selecting, based on the number of the PUSCHs having the earliest position in the time domain being equal to one, the PUSCH having the earliest position in the time domain; and selecting, based on the number of the PUSCHs having the earliest position in the time domain being greater than one, the PUSCH associated with the one serving cell based on at least one of: comparing serving cell indexes of the one or more of the plurality of serving cells, comparing durations in the time domain of the PUSCHs associated with the one or more of the plurality of serving cells, comparing numbers of symbols associated with the PUSCHs associated with the one or more of the plurality of serving cells, comparing bandwidths of the PUSCHs associated with the one or more of the plurality of serving cells, comparing numbers of resource blocks of the PUSCHs associated with the one or more of the plurality of serving cells, or comparing numbers of resource elements of the PUSCHs associated with the one or more of the plurality of serving cells.

In one example, a non-transitory machine-readable storage medium of a wireless terminal storing computer-executable instructions for channel state information (CSI) reporting in a multi-cell scheduling environment of a New Radio (NR) system, the computer-executable instructions for: receiving, in a physical downlink control channel (PDCCH) associated with a first serving cell of a plurality of serving cells, downlink control information (DCI) including: configuration information for one or more physical uplink shared channels (PUSCHs), each PUSCH of the one or more PUSCHs being associated with a corresponding one of one or more of the plurality of serving cells, and trigger information to trigger a generation of a CSI report at the wireless terminal; generating, in response to receiving the trigger information, the CSI report; selecting the PUSCH associated with one serving cell of the one or more of the plurality of serving cells; and transmitting the CSI report on the PUSCH associated with the one serving cell.

### CROSS REFERENCE

This Nonprovisional application claims priority under 35 U.S.C. § 119 on provisional Application No. 63/407,535 on Sep. 16, 2022, the entire contents of which are hereby incorporated by reference.

1. A wireless terminal for channel status information (CSI) reporting in a multi-cell scheduling environment, the wireless terminal comprising:
a transmitter;
a receiver;
one or more non-transitory computer-readable media storing computer-executable instructions; and
at least one processor coupled to the one or more non-transitory computer-readable media and configured to execute the computer-executable instructions to cause the wireless terminal to perform operations comprising:
receiving, by the receiver, in a physical downlink control channel (PDCCH) associated with a first serving cell of a plurality of serving cells, downlink control information (DCI) including:
configuration information for more than one physical uplink shared channels (PUSCHs), each PUSCH of the more than one PUSCHs being associated with a corresponding one of more than one of the plurality of serving cells, and
trigger information to trigger a CSI report at the wireless terminal;
generating, in response to receiving the trigger information, the CSI report;
selecting the PUSCH associated with one serving cell of the more than one of the plurality of serving cells; and
transmitting, by the transmitter, the CSI report on the selected PUSCH.

2. The wireless terminal of claim 1, wherein:
the one serving cell is a serving cell with the lowest serving cell index of the more than one of the plurality of serving cells.

3-15. (canceled)

16. A method performed by a wireless terminal for channel status information (CSI) reporting in a multi-cell scheduling environment, the method comprising:
receiving in a physical downlink control channel (PDCCH) associated with a first serving cell of a plurality of serving cells, downlink control information (DCI) including:
configuration information for more than one physical uplink shared channel (PUSCH), each PUSCH of the more than one PUSCH being associated with a corresponding one of more than one of the plurality of serving cells, and
trigger information to trigger a CSI report at the wireless terminal;
generating, in response to receiving the trigger information, the CSI report;
selecting the PUSCH associated with one serving cell of the more than one of the plurality of serving cells; and
transmitting the CSI report on the selected PUSCH.
